(19) United States
(12) Patent Application Publication
(10) Pub. No.: US 2003/0057029 A1
(43) Pub. Date: Mar. 27, 2003

(54) Managing method and system for building equipment and elevator

(76) Inventors: Atsuya Fujino, Hitachinaka (JP); Toshihiko Hatakeyama, Ushiku (JP); Seiji Kawanishi, Koshigaya (JP); Yoshio Matsuzaki, Tokyo (JP); Takashi Matsudo, Mito (JP); Osamu Dohi, Hitachinaka (JP); Isamu Mutou, Naka-gun (JP); Hiroshi Nagase, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/252,507

(22) Filed: Sep. 24, 2002

(30) Foreign Application Priority Data
Sep. 26, 2001 (JP) 2001-293980

(51) Int. Cl. B66B 3/00

(52) U.S. Cl. 187/391; 187/396

(57) ABSTRACT

Disclosed herein is a building equipment managing method using a history database for recording the conditions of building equipment, a display device installed in public spaces of a building, and an input device installed in the public spaces of the building for inputting a request for the indication of necessary information, the method comprising the steps of: recording a change in a condition of the building equipment in the history database; and in response to receiving a request for indicating a content which is recorded in the history database from the input device, indicating on the display device the content which is recorded in the history database.

### BACKGROUND OF THE INVENTION

The present invention relates to a building equipment and elevator managing method and a building equipment and elevator managing system, and more particularly to a building equipment and elevator managing method and a building equipment and elevator managing system suitable for enabling each of the occupants of a building, especially the occupants of condominiums, to confirm histories of changes in the condition and the operating conditions of building equipment, by means of display devices installed in the public space (hereinafter referred to as the “public space”) such as the elevator hall and the elevator cars in such a building.

The elevator is one of the principal pieces of building equipment primarily serving for the transportation within a building and is subject to periodical inspection for maintaining its function. Further, the recent elevator is provided with an abnormality monitoring system so that the occurrence and the sign of abnormality are detected to be notified to a remote monitoring center.

For the information on histories of operating conditions of the elevator, Japanese Patent Laid-Open No. 4-313581 discloses a monitoring system capable of recording and storing various histories including the past troubles, alarms or the like, while Japanese Patent Laid-Open No. 8-310760 discloses a system for enabling the history of repair works to be displayed on and printed by means of a portable terminal to be carried by each serviceman.

For the confirmation of the condition of each elevator from the monitoring center, Japanese Patent Laid-Open No. 2000-090374 discloses a method for indicating, for confirmation, the operating signal currently used in the elevator control circuit on the display device in the maintenance control center.

For a method for confirming the condition of maintenance of each elevator from the monitoring center, Japanese Patent Laid-Open No. 11-272972 discloses a method for transmitting the signal telling the maintenance and inspection work is in progress when a card is kept inserted into a terminal of the remote monitoring system while transmitting the signal telling the completion of the maintenance and inspection work when the card is removed from the terminal.

Further, the methods for obtaining the information concerning the operating condition, maintenance date and the condition of trouble of each elevator by specific combinations of the push-buttons of the display devices installed in the elevator hall and/or in elevator cars are, for instance, disclosed by Japanese Patent Laid-Open Nos. 2001-031344 and 2001-106450.

Building equipment and equipment relating to the building in general include various facilities such as elevators, power supply equipment, pumping and water service equipment, illumination equipment, air conditioning equipment, entrance/exit control equipment, a front door, disaster preventive equipment, a crime prevention camera, and a parking facility. These various facilities are individually provided with control systems, monitoring systems, and abnormality notification systems.

In many instances, various pieces of building equipment and various pieces of equipment relating to the building are individually provided with control systems and abnormality notification systems, which results in that individual buildings are provided with similar pieces of equipment having similar functions. This is now considered to be the waste of resource, thereby giving rise to the necessity of the improvement in control efficiency (through the introduction of the collective equipment control system for a plurality of buildings).

On the other hand, however, the emergences of advanced monitoring system, abnormality notification system and remote control system enable the time required between the occurrence of trouble of the building equipment and the recovery of normal state by repairing to be shortened so much that even the individual occupants of each building are hardly aware of the occurrence of trouble and the following execution of the repair work. As a result, the individual occupants of each building tend to be lessening their concerns with the relationship between the administration expenses they will pay and the maintenance and inspection expense for the building they occupy.

### SUMMARY OF THE INVENTION

A first object of the present invention is to provide a managing method and a managing system of building equipment designed for being capable of easily providing the occupants of the building with the information on the conditions, troubles, repairs and the like of the building equipment.

Further, it is difficult for any single business organization to provide a common control system applicarle to many different types of building equipment, and thus it becomes reasonable for various pieces of equipment in different buildings to be controlled, for the maintenance and inspection, jointly with a plurality of business organizations and contractors. On the other hand, when the maintenance and inspection services are provided by a plurality of servicing companies and a plurality of servicemen, there is the possibility that the qualities of the services cannot necessarily be maintained at desired high levels at all times. The prior art disclosed in the Japanese Patent Laid-Open No. 11-272972 is designed only for enabling the monitoring center to confirm the maintenance and inspection work in progress and the completion of the maintenance and inspection work and is not designed for providing the information on the inspection of the building equipment to the occupants of the building nor designed for evaluating the levels of the services provided by a plurality of servicing companies and a plurality of servicemen.

A second object of the present invention is to provide a managing method and a managing system for the building equipment designed not only for being capable of evaluating the levels of the services provided by a plurality of servicing companies and a plurality of servicemen but also for being suitable for providing highly satisfactory services to the occupants of the building.

The present invention, in one aspect, comprises a equipment condition history database for recording the information on the past troubles and repairs of a building, the display devices installed in public spaces such as an elevator hall and/or in an elevator car where the existences of such display devices can readily be recognized for use by the individual occupants of the building, and an input device whereby a request for the indication of the information on the condition of the building equipment can be inputted for being displayed on each display device in response to the input of a request for such indication by each occupant of the building.

The present invention, in another aspect, comprises a control system installed for each building, display devices and input devices installed in an elevator hall and/or in an elevator car, a monitoring center connected with the control systems each installed in a plurality of buildings, a database for individual servicemen provided in the monitoring center, and a means for updating through the input device the database for individual servicemen by inputting the data of the individual services provided to the building concerned.

Many other features of the present invention will be described in the embodiments which will be described in the following.

### BRIEF DESCRIPTION OF THE DRAWINGS

Other objects and advantages of the invention will become apparent from the following description of embodiments with reference to the accompanying drawings in which:

FIG. 1 is a diagram showing the configuration of building equipment and elevator managing system according to an embodiment of the present invention;

FIG. 2 is a diagram describing the outline of the building equipment and elevator managing system according to an embodiment of the present invention;

FIG. 3 is a diagram showing an example of a equipment control program according to an embodiment of the present invention;

FIG. 4 is a diagram showing an example of a program applicarle during the progress of a repair work according to an embodiment of the present invention;

FIG. 5 is a diagram showing an example of an abnormality analysis program in a monitoring center according to an embodiment of the present invention;

FIG. 6 is a diagram showing an example of a program for a completed repair work to be executed in the monitoring center according to an embodiment of the present invention;

FIG. 7 is a diagram showing an example of a program for confirming histories of equipment according to an embodiment of the present invention;

FIG. 8 is a diagram showing an example of the layout of display areas in a display device according to an embodiment of the present invention; and

FIG. 9 is a diagram showing examples of the written indications on the display device according to an embodiment of the present invention.

### DESCRIPTION OF THE PREFERRED EMBODIMENTS

An embodiment of the present invention will be described below in reference with accompanying drawings.

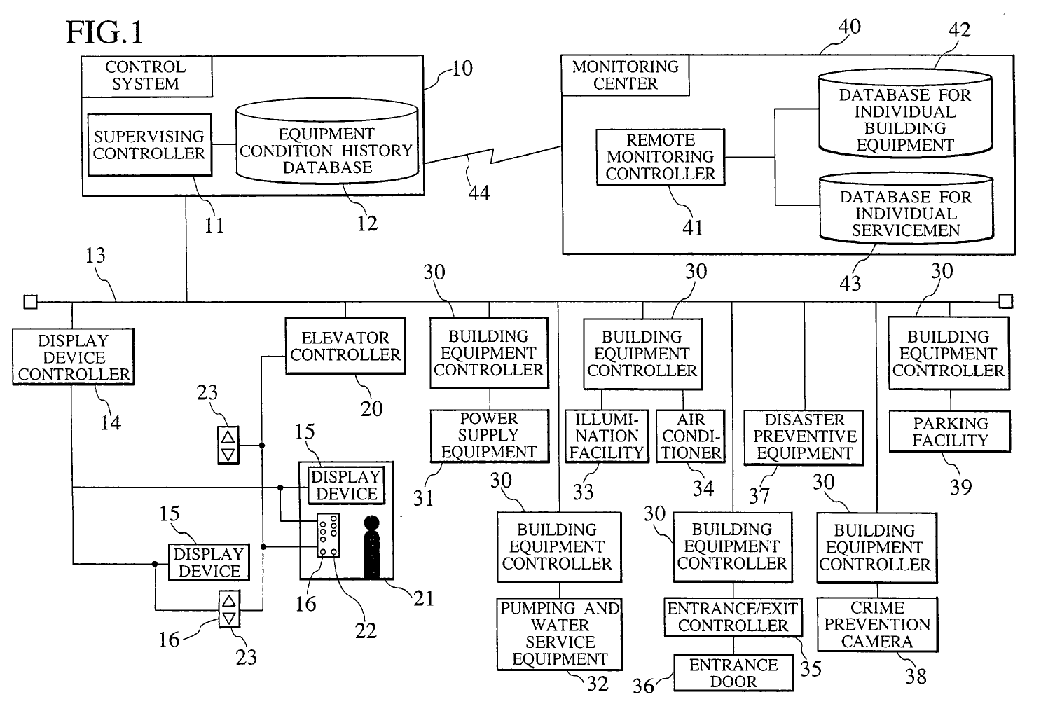

FIG. 1 is a system configuration diagram of a managing system of building equipment and elevator according to an embodiment of the present invention. The managing system mainly comprises a control system 10, a display device 15, an input device 16, an elevator controller 20, controllers 30 for various pieces of building equipment, and a monitoring center 40.

The control system 10 comprises a supervisory controller 11 for executing various processing, which will be described later, and a building equipment condition database 12 that records changes in the building equipment condition. The control system 10 is connected with various controllers through an equipment control network 13.

The content of the information indicated on the display devices 15 which are installed in the public spaces such as an elevator hall and/or an elevator car where the display devices are readily recognized by the individual occupants of the building is controlled by a display device controller 14. Further, the input device 16 is installed near the display device 15. In the case of an example given in FIG. 1, a floor selecting button 22 in the elevator car 21 and a call button 23 in the elevator hall also serve as the input devices 16.

Further, the building equipment includes a power supply equipment 31, pumping and water service equipment 32, an illumination facility 33, an air conditioner 34, an entrance/exit controller 35, an entrance door 36, disaster preventive equipment 37, a crime prevention camera 38, a parking facility 39 and the like. In many instances, a building equipment controller 30 is provided for each building equipment; however, the illumination facility 33 and the air conditioner 34 are controlled by the building equipment controller 30 common to each other, the entrance door 36 is connected with the entrance/exit control system 35 of other building equipment and the disaster preventive equipment 37 does not have a specific controller 30 of the building equipment.

The monitoring center 40 is provided with a remote monitoring controller 41 for processing at the monitoring center, which will be described later, a database for individual building equipment 42 associated with the equipment condition database 12, and a database for individual servicemen 43, which are respectively connected with the control system 10 through a communication line 44.

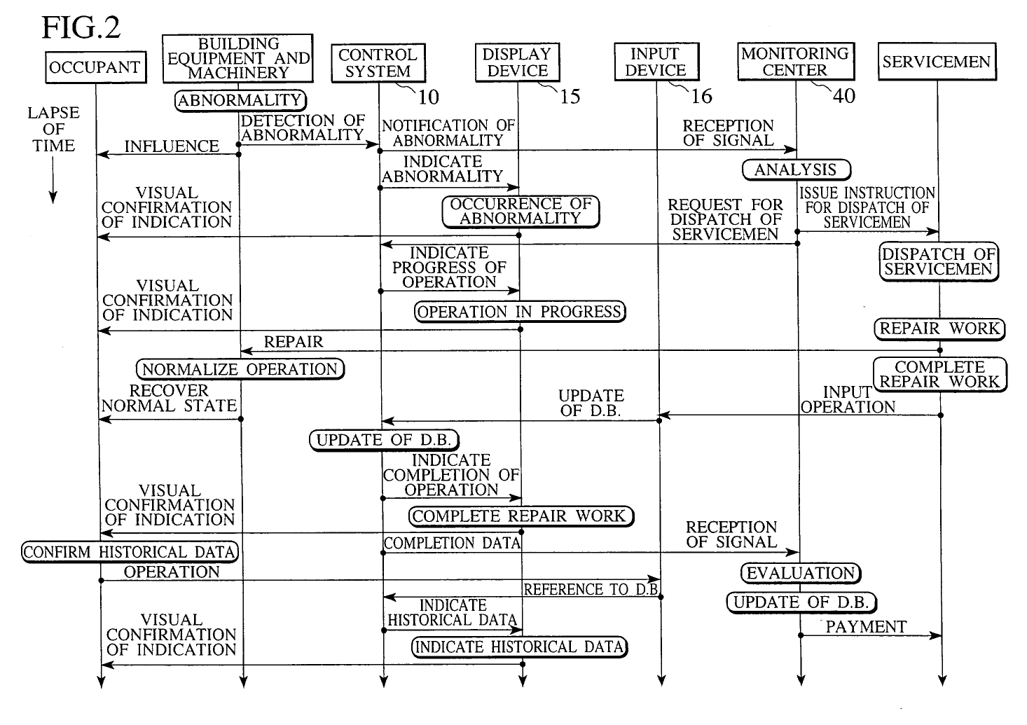

FIG. 2 is a diagram illustrating the outline of a managing system of the building equipment and the elevator according to an embodiment of the present invention. FIG. 2 shows the actions of various pieces of the building equipment, various systems, individual occupants of the building, and individual servicemen to be taken with the lapse of the time.

When any trouble occurs with any piece of building equipment or any unit of machinery, an abnormality detection signal is outputted to the control system 10, and such abnormality will more or less influence the occupants of the building. Upon reception of the abnormality detection signal, the control system 10 not only notifies the monitoring center of the occurrence of the abnormality 40 but also makes the display device 15 indicate the occurrence of the abnormality so that the individual occupants of the building will either visually or aurally be notified of the occurrence of the abnormality. The monitoring center 40, upon reception of the signal telling the occurrence of the abnormality, analyzes the abnormality not only to demand the dispatch of the servicemen, if necessary, but also to transmit the actions to be taken, including the dispatch of the servicemen and the provision of the information on how to cope with the abnormality, to the control system 10. The control system 10, upon reception of the demand for the dispatch of the servicemen or the instruction for how to cope with the abnormality, makes the display device 15 indicate the progress of the measures taken against the abnormality and the progress of the repair work so that the individual occupants of the building will be able to know visually that the countermeasure against the abnormality is currently in progress. When the servicemen are called out by the monitoring center 40, the servicemen are dispatched for repair work to the building concerned. When the normal state of the building equipment or machinery concerned is recovered, the occupants will not be influenced and the normal state of living for the individual occupants of the building will also be recovered. Each serviceman who has finished its service inputs the information telling the finish of the service to the input device 16. Upon reception of the input by the serviceman, the control system 10 updates the content of the equipment condition database 12 and makes the display device 15 indicate the completion of the repair work so that the individual occupants of the building will be able to visually confirm the completion of the repair work. The control system 10 transmits the data of the completed repair work to the monitoring center 40, and the monitoring center 40 not only evaluates the repair work but also updates the database for individual building equipment 42 and the database for individual servicemen 43 to process the data for the payments to be made to the individual servicemen and the service companies.

A series of processing operations are completed by going through the above-mentioned steps.

Furthermore, it is possible for each of the individual occupants of the building to confirm the content of the database 12 for changes in the conditions of the individual building equipment and machinery. In other words, by inputting the demand for that purpose to the input device 16, it is possible for any occupant of the building to refer to the content of the building equipment condition database 12 and to display it on the display device 15, thereby visually confirming changes in the conditions of the building equipment and machinery.

An example of the program for the processing described above will be described below referring to a corresponding flow chart.

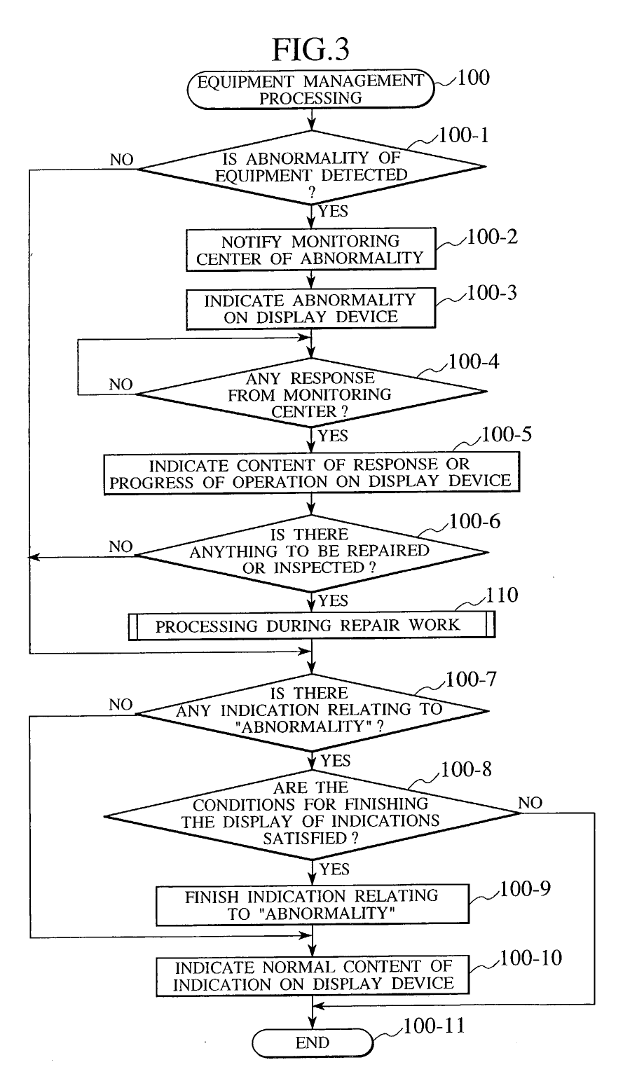

FIG. 3 is a diagram illustrating a program for building equipment control processing 100. The building equipment control processing program 100 is executed by the supervisory controller 11 of the control system 10. Similarly to the case of the processing program described below, the start and stop of the program are made either periodically or by means of the interrupt request signal when necessary by operation of the operation system (not shown).

When the abnormality of the equipment is detected in step 100-1, the signal notifying the occurrence of the abnormality is sent to the monitoring center 40 in step 100-2, and the occurrence of the abnormality is made to be indicated on the display device 15 in step 100-3. In step 100-4, the response from the monitoring center 40 is awaited, and the content of the response or the progress of the processing is made to be indicated on the display device 15 in step 100-5 when the response is received. The content of response or the progress of the processing will be described later.

When it is found, from the response signal of the monitoring center 40, that there is the need of repair or inspection in step 100-6, the processing proceeds to the subroutine 110 for the processing during the repair work which will be described later.

When the processing during the repair work in step 110 is finished, or when no abnormality of the equipment is detected in step 100-1 and when it is found, in step 100-6, that there is no need of the repair or inspection, the processing proceeds to the processing from step 100-7 and the following steps. In step 100-7, it is confirmed whether there is any indication relating to “abnormality” on the display device. The indication relating to “abnormality” means the indication that abnormal condition remains unremoved in steps 100-3 and 100-5 or the indication that the repair work has been completed in step 110-7 in the case where the repair work is completed by the processing 110 during the repair work as is described later. When the indication relating to “abnormality” is made in step 100-7, the conditions for terminating the indication needs to be confirmed in step 100-8. The conditions for terminating the indication can be the expiration of indication period such as that 3 days have passed from the time when the indication of the completion of the repair work was made, or the confirmation of the completion of the repair work, through the input device 16, made by any one of the occupants who had noticed the indication of the completion of the repair work, or the input of the command requiring the termination of the display, which can be arbitrarily set depending on the condition of the building concerned.

When the conditions for terminating the indication of abnormality are not satisfied in step 100-8, the equipment control processing 100 is terminated without executing the following steps in order to continue the indication of the abnormality. When the conditions for terminating the indication of the abnormality in step 100-8 are satisfied, the indication relating to “abnormality” is terminated in step 100-9. When the indication relating to “abnormality” is not made in step 100-7 or when the indication relating to “abnormality” is terminated in step 100-9, the command for the indication of ordinary information is given to the display device 15 in step 100-10 to terminate the equipment control processing 100.

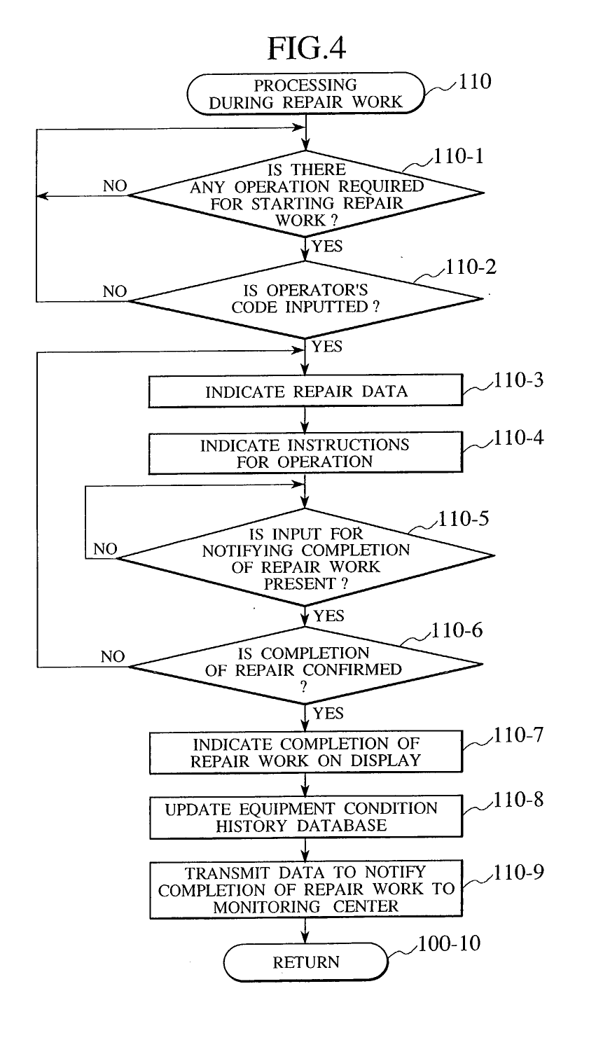

FIG. 4 shows an example of a program for processing during the repair work 110. When it is found that there are needs of repair work and inspection in the previously mentioned step 100-6, step 110-1 is for awaiting the input of the command for the start of repair work by a serviceman to the input device 16. When the input of the command for the start of the repair work is made by a serviceman in step 110-1 and when the identification code of one who has operated the input device coincides with a regular code, the processing proceeds to the following steps.

In step 110-3, the information necessary for the trouble or repair of the building equipment is made to be indicated on the display device 15. In step 110-4, the instructions relating to the repair work of the building equipment, if any, are made to be indicated on the display device 15. The step 110-3 and 110-4 provide the serviceman concerned with necessary assistances for their works from the control system 10 and the monitoring center 40.

In step 110-5, the input of the information for notifying the completion of the repair work by the serviceman concerned is awaited, and when the input for notifying the completion of the repair work is made, the control system 10 checks the conditions of the serviced building equipment or machinery to examine whether it is repaired satisfactorily in step 110-6. Until the result of the repair work is approved, the processing returns to the step 110-3 to repeat the previously mentioned processing. When the completion of the repair work is confirmed in step 110-6, the completion of the repair work is indicated on the display device 15 in step 110-7. Following the completion of the repair work, in step 110-8, the equipment conditions database 12 is updated, and in step 110-9, the data relating the completion of the repair work (the input by each serviceman and the data of the equipment condition confirmed by the control system 10) is transmitted to the monitoring center 40 to return to the stage 100 for the equipment control processing from the stage 110 for the processing during the repair work.

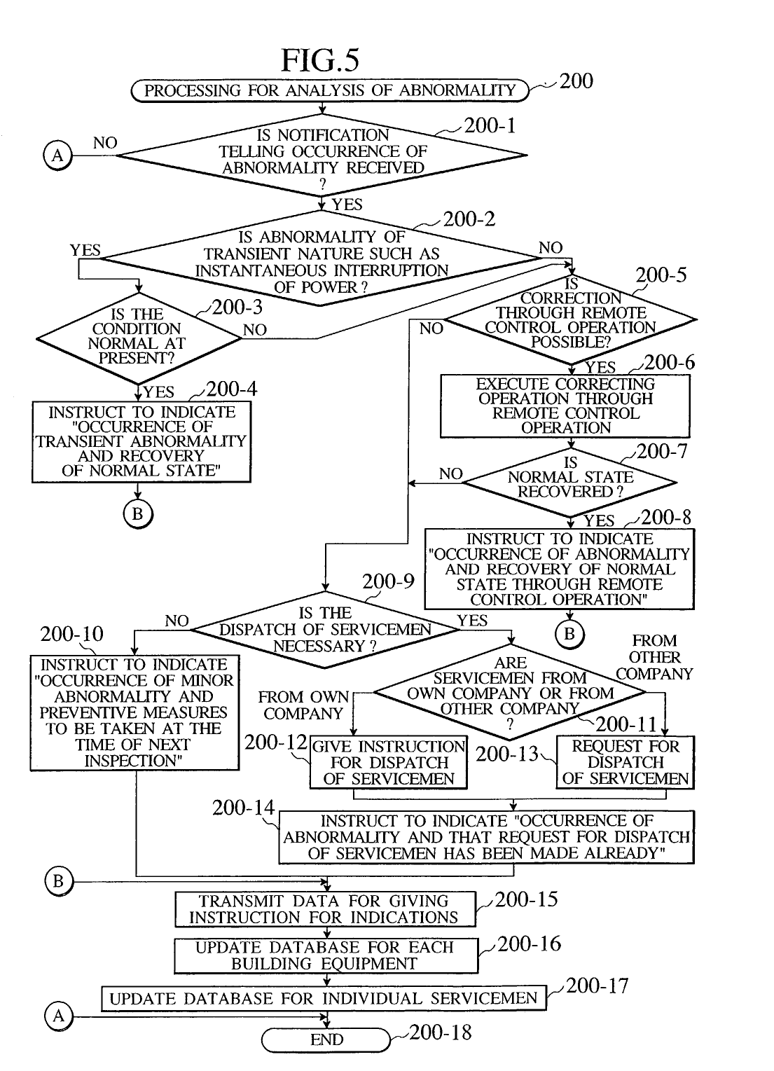

FIG. 5 is a flowchart corresponding to a program for abnormality analysis processing 200 by the monitoring center. Upon reception of the notification from the previous step 100-2 by the monitoring center 40, the abnormality analysis processing 200 by the monitoring center 40 is started. When the signal notifying the abnormality of the equipment is received in step 200-1, whether the abnormality is of transient nature such as the instantaneous interruption of the power supply or not is confirmed in step 200-2. When it is confirmed that the abnormality is of transient nature in step 200-2, whether the present state is normal or not is confirmed in step 200-3. When it is confirmed that the present state is normal in step 200-3, there are no needs of repair work and inspection, so that the command for making the indication of “The transient abnormality has been removed and the normal state is recovered” is selected in step 200-4 to let the processing jump to stage B.

When it is found that the present state is not normal in step 200-3, or when it is found that the abnormality is not transient one in step 200-2, whether the abnormality can be corrected through the remote control from the monitoring center 40 needs to be confirmed in step 200-5. The correction through the remote control system means to correct any temporary abnormal condition of the program by re-writing such data through the remote control system. When the correction through the remote control system is possible in step 200-5, the correcting operation through the remote control system is executed in step 200-6, and whether the normal state is recovered is confirmed in step 200-7. When the normal state is recovered in step 200-7, the indication, “The abnormality is removed, and normal state is recovered by remote control”, is made in step 200-8 to let the processing jump to stage B.

When the normal state cannot be recovered in step 200-7, or when the correction through the remote control system in step 200-5 is not possible, it is necessary to confirm whether the abnormality requires the dispatch of the servicemen for repairing or not in step 200-9. When the abnormality is minor one and thus the dispatch of the servicemen is not necessary, the command for the indication, “A minor abnormality that can be corrected at the time of the next inspection”, needs to be selected in step 200-10. When it is found necessary to dispatch the servicemen in step 200-9, it is necessary to confirm whether the servicemen need to be dispatched from own company or from other company in step 200-11, and when the servicemen need to be dispatched from own company, the command for indicating the need of the dispatch of the servicemen of own company is inputted in step 200-12. When it is found that the servicemen of other company need to be dispatched in step 200-11, reference is made to the database for individual servicemen to select the company and the servicemen to which the servicing is to be entrusted, and the command for requesting the dispatch of the servicemen is inputted in step 200-13. Then, the command for the indication, “An abnormality has occurred and the request for dispatch of servicemen has been made” is selected in step 200-14.

As discussed in the above, for the abnormality analysis processing 200, since how to cope with the abnormality is decided in one of steps 200-4, 200-8, 200-10 or 200-14, the data for the commanded indications is transmitted to the control system 10. Then, the database for individual building equipment 42 is updated in step 200-16, and the database for individual servicemen 43 is updated in step 200-17.

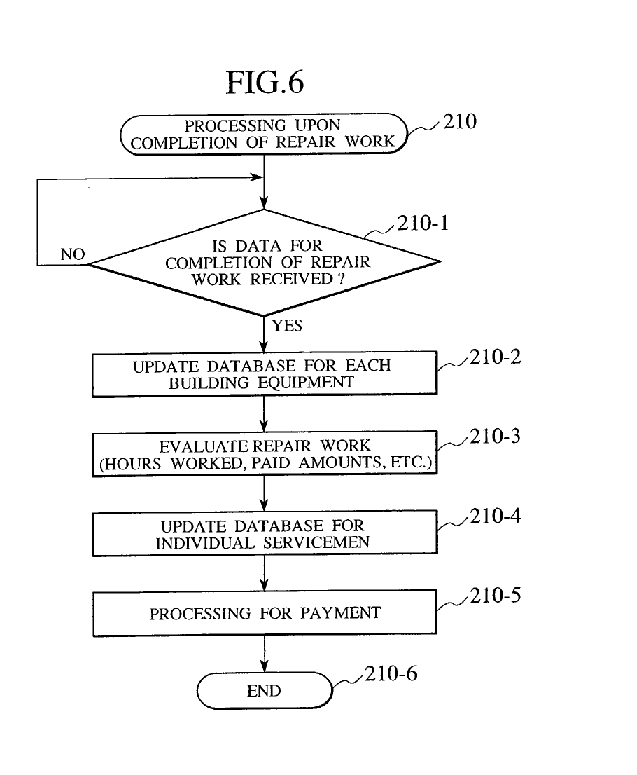

FIG. 6 shows an example of a program for processing to be executed 210 by the monitoring center when the repair work is completed. When the command for requesting the dispatch of the servicemen is inputted in the course of the previously mentioned abnormality analysis processing 200, the data relating to the completion of the repair work from the control system 10 is awaited in step 210-1 of the processing stage 210. When the completed repair work data is received in step 210-1, the database for individual building equipment 42 is updated in step 210-2. Then, the repair work is evaluated in step 210-3. The repair work is evaluated in terms of the degree of difficulty of the abnormality, length of repair work time it takes from the command for dispatch of the servicemen to the completion of the work, the frequency of servicing required before completing the repair work or the like so that the amount of the payment for the servicing can be decided according to the rating of the quality of servicing. In step 210-4, the database for individual servicemen 43 is updated according to the result of the evaluation. In step 210-5, processing is executed for the payments to the contracted company and servicemen.

By going through the steps given in FIG. 3 through FIG. 6 a series of processing for coping with the abnormality by the control system 10 and the monitoring center 40 can be completed.

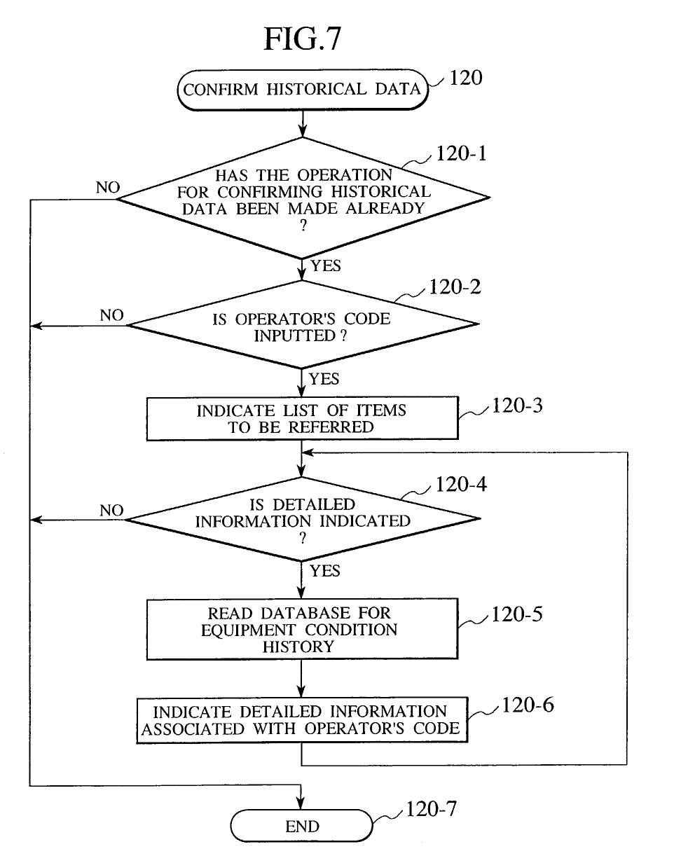

FIG. 7 shows an example of a program for building equipment history processing 120. The occupants of the building can confirm the content of the building equipment condition database 12 which stores the data of the change in the building equipment and machinery condition in the past. The operation for confirming the building equipment conditions is made in step 120-1, and the building equipment historical data can be indicated on the display device 15 in step 120-2, provided that the identification code of the operator coincides with a regular code. In step 120-3, the list of the historical data to be displayed can be displayed. When the command for requesting the indication of the detailed information is inputted in step 120-4, the building equipment condition database 12 is read out in step 120-5, and the detailed information is indicated in step 120-6 in response to the identification code of the operator. The processing comes to an end when there is no input of the command for the indication of the detailed information in step 120-4.

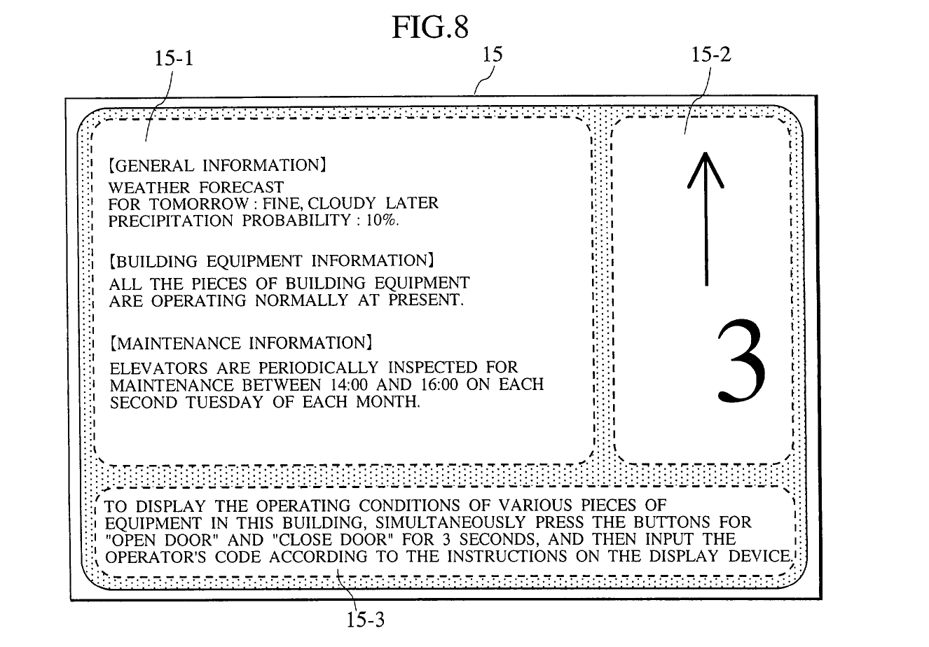

FIG. 8 shows an example of the layout of display areas of a display device for the indication of the data. In general, the display device 15 capable of displaying the characters and diagrams and commonly used for the display devices of the computers are used, but, (in the case of the present invention) the display device needs to include the information display area 15-1 for displaying the information of the building equipment out of the contents of the building equipment condition database 12.

When installing the display device 15 in the elevator hall or the elevator car, it is convenient for the users that the display area of the display device is designed to include the elevator information area 15-2 which serve as the floor selector to indicate the position of the car. Besides, in many of the cases where the floor selecting buttons 22 and the call buttons 23 are designed to serve as the input device 16 too, each user is required to follow some special instructions to operate these buttons because of the limited number of the buttons and thus it is convenient for the users to have an operating procedure explanation area 15-3.

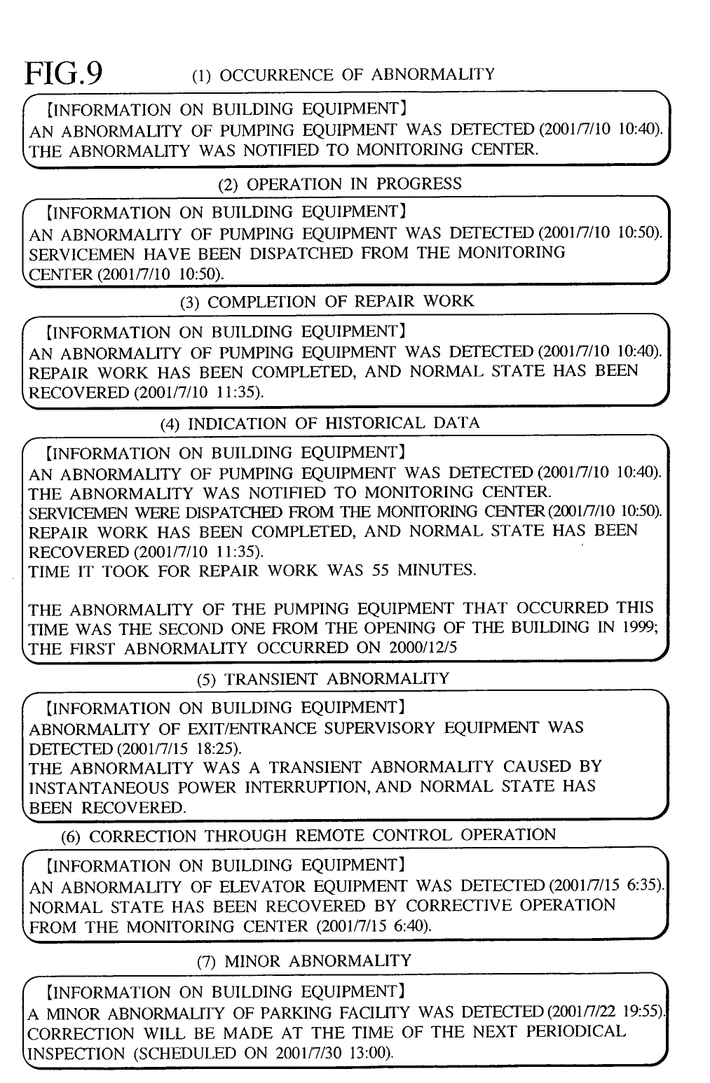

FIG. 9 shows examples of the written information to be indicated on the display device. These indications respectively correspond to a series of processing to be executed from the time of the occurrence of any abnormality such as the processing to be executed (1) at the time of occurrence of abnormality, (2) at the time of the operation in progress and (3) at the time of the completion of repair work.

Each occupant of the building who has operated the buttons for the history of the building equipment or machinery will have the histories such as one described in FIG. 9 (4) indicated on the display device. For the abnormality of transient nature to be processed in the previously mentioned step 200-4, the indication as in FIG. 9 (5) is displayed; for the correction through the remote control system to be processed in step 200-8, the indication as in FIG. 9 (6) is displayed; for the minor abnormality to be processed in step 200-1, the indication as in FIG. 9 (7) is displayed.

The examples given in FIG. 9 are no more than the examples for explanation and thus are subject to proper modification depending on the individual situations.

According to the embodiment discussed above, the building equipment and elevator managing system comprises the control system 10 installed in each building, the display device 15 installed in the elevator hall and/or in the car 21 of each elevator, and the monitoring center 40 connected with the control systems in a plurality of buildings. The building equipment and elevator managing system comprises the equipment condition database 12 provided in the control system 10 in order to record the change in the conditions of the individual pieces of the building equipment 20, 31 through 39, the database for individual building equipment 42, and the database for individual servicemen 43, respectively associated with the building equipment condition database 12 provided in the monitoring center 40, the input device 16 for inputting the command for requesting the content of the service to the building equipment and the indication on the display device 15, the display controller 14 for letting the content of the building equipment condition database 12 be indicated on the display device 15, and the record control means (installed in the remote monitoring controller 41) for updating the database for individual servicemen according to the data concerning the content of the service inputted through the input device 16.

According to the present embodiment, it is possible for any occupant of the building to readily have the information concerning the troubles and repairs of the building equipment indicated selectively on the display device. Further, the present embodiment makes it possible for each occupant of the building to have the information concerning the levels of the services provided from a plurality of contracted companies and their servicemen indicated on-demand-basis, thereby providing the occupants of the building with high-quality services. Furthermore, the present embodiment enables the occupants of the building to have the information concerning the abnormality such as the transient abnormality which did not require the dispatch of the servicemen reported or disclosed.

With respect to the above-mentioned embodiments of the present invention, there are provided features as are described below besides those recited in the claims.

### Feature 12

In a building equipment and elevator managing method using a control system installed for each building, input devices installed in an elevator hall and/or in an elevator car, and a monitoring center connected with control systems each installed in a plurality of buildings, the method comprises the steps: providing the monitoring center with a database for individual building equipment and a database for individual servicemen; notifying the monitoring center of the occurrence abnormality to, this step being executed by the control system; deciding on the dispatch of the servicemen, this step being executed by the monitoring center; transmitting the data concerning the completion of the repair work to the monitoring center in response to the input of the data concerning the completion of the repair work inputted from the input device, this step being executed by the control system; and updating the content of the database for individual servicemen, this step being executed by the monitoring center.

### Feature 13

There is provided a building equipment and elevator managing method according to the feature 12, wherein the step in which the monitoring center decides on the dispatch of the servicemen includes the step of selecting the servicemen to be dispatched according to the content of the record in the database for individual servicemen.

### Feature 14

In a building equipment and elevator managing method using a control system installed for each building, display devices installed in an elevator hall and/or in an elevator car, and a monitoring center connected with control systems each installed in a plurality of buildings, the method uses an input device installed in the vicinity of the display device, the control system executing: a step of detecting abnormality of building equipment; a step of notifying a monitoring center of the occurrence of the abnormality; a step of letting the display device indicate the occurrence of the abnormality; a step of receiving the response from the monitoring center; a step of letting the display device indicate the content of the response from the monitoring center; a step of updating the database according to the input from the input device; a step of letting the display device indicate the information concerning the completion of the repair work; and a step of transmitting the data concerning the completed repair work to the monitoring center.

### Feature 15

In a building equipment and elevator managing method using a control system installed for each building, display devices and input devices installed in an elevator hall and/or in an elevator car, and a monitoring center connected with control systems each installed in a plurality of buildings, the method includes a step of receiving the signal telling the occurrence of abnormality from the monitoring center; a step of analyzing the nature of the abnormality; a step of requesting the dispatch of the servicemen; a step of transmitting the content of the response to the notification of the abnormality to the control system; a step of receiving data concerning the completion of the repair work from the control system; a step of evaluating the quality of service of each serviceman; a step of updating the database for individual servicemen; a step of updating the database for individual servicemen; and a step of processing concerning the payments to individual servicemen and the companies to which they belong.

The present invention readily enables each occupant of a building to selectively and visually access the information concerning the trouble and repair of the building equipment by having such information indicated on the display device.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A building equipment managing method using a history database for recording the conditions of building equipment, a display device installed in public spaces of a building, and an input device installed in the public spaces of the building for inputting a request for the indication of necessary information, the method comprising the steps of:
recording a change in a condition of the building equipment in the history database; and
in response to receiving a request for indicating a content which is recorded in the history database from the input device, indicating on the display device the content which is recorded in the history database.

2. A building equipment and elevator managing method using a history database for recording the conditions of building equipment, display devices installed in an elevator hall and/or in an elevator car, and input devices installed in the vicinity of the display devices for inputting a request for the indication of necessary information to the display device, the method comprising the steps of:
recording a change in a condition of the building equipment in the history database; and
in response to receiving a request for indicating a content which is recorded in the history database from the input device, indicating on the display device the content which is recorded in the history database.

3. A building equipment and elevator managing system, comprising:
display devices installed in an elevator hall and/or in an elevator car;
input devices installed in the vicinity of the display devices for inputting a request for indicating necessary information on the display device;
a history database for recording a change in a condition of building equipment; and
in response to receiving a request for the indication of a content which is recorded in the history database from the input device, a display controller for indicating on the display device the content which is recorded in the history database.

4. A building equipment managing method using a history database for recording the conditions of building equipment, and display devices and input devices installed in an elevator hall and/or an elevator car, the method comprising the steps of:
recording a change in a condition of the building equipment in the history database; and
indicating on the display device a content which is recorded in the history database in response to an identification code and a request for the indication inputted from the input device.

5. A building equipment and elevator managing system, comprising:
display devices and input devices installed in an elevator hall and/or an elevator car; and
a history database for recording a change in a condition of building equipment;
wherein each of the display devices has a display area thereon, the display area including an information indication area for indicating a content which is recorded in the history database; an elevator information area for indicating the location and the direction of travel of each elevator; and an operating procedure explanation area for instructing the operating procedure for each of the input devices.

6. A building equipment and elevator managing method using a control system installed for each building, a monitoring center connected with control systems each installed in a plurality of buildings, and display devices installed in an elevator hall and/or in an elevator car, the method comprising the steps of:
indicating the occurrence of abnormality of building equipment on each of the display devices;
notifying a monitoring center of such abnormality;
indicating a response from the monitoring center; and
indicating the completion of repair work for removing the abnormality.

7. The building equipment and elevator managing method according to claim 6, further comprising the steps of:
recording a change in a condition of the building equipment in the history database; and
indicating a content which is recorded in the history database in response to receiving a request for indication.

8. The building equipment and elevator managing method according to claim 6, further comprising a step of indicating the occurrence of transient abnormality of the building equipment, correction made by the monitoring center through remote control operation, or the occurrence of any minor abnormality to be corrected at the time of the next periodical inspection.

9. The building equipment and elevator control method according to claim 6, wherein the step of indicating the completion of repair work is continued until a predetermined condition is satisfied.

10. A building equipment and elevator managing method using a control system installed for each building, display devices and input devices installed in an elevator hall and/or in an elevator car, and a monitoring center connected with control systems each installed in a plurality of buildings, the method comprising the steps of:
updating the content of a database for individual building equipment in the control system in response to receiving the information notifying the completion of repair work from the input device.

11. A building equipment and elevators managing system including a control system installed for each building, display devices installed in an elevator hall and/or in an elevator car, and a monitoring center connected with control systems installed in a plurality of buildings, the system comprising:
an equipment condition history database installed in the control system for recording a change in a condition of building equipment;
a database for individual building equipment and a database for individual servicemen installed in the monitoring center and associated with the history database;
an input device for inputting the information on the content of the service to the building equipment and for inputting a request for the indication on the display device;
a display controller for indicating the content of the history database on the display device in response to the inputted request; and
record control means for updating the database for individual servicemen according to the information concerning the content of the service inputted through the input device.
